(19) United States
(12) Patent Application Publication
(10) Pub. No.: US 2004/0148365 A1
(43) Pub. Date: Jul. 29, 2004

(54) System and method for vectored sendfile

(76) Inventor: Sunay Tripathi, San Jose, CA (US)

Correspondence Address: WAGNER, MURABITO & HAO LLP, Third Floor, Two North Market Street, San Jose, CA, 95113, US

(21) Appl. No.: 10/351,029

(22) Filed: Jan. 24, 2003

(51) Int. Cl. G06F 15/16

(52) U.S. Cl. 709/218

(57) ABSTRACT

A system and method for vectored sendfile are presented. Embodiments of the present invention include a method for providing information comprising: accessing a data request associated with a user, wherein the data request comprises multiple data files; identifying file descriptors associated with the data files; retrieving the file descriptors associated with the data files; and providing the file descriptors as a file vector to a system kernel in a single system call.

### BACKGROUND OF THE INVENTION

1. Field of the Invention

The field of the invention relates to data processing. More specifically, embodiments of the present invention relate to a system and method for accessing a request for data and in response to the request, sending multiple file pointers associated with the request in a single system call.

2. Related Art

Typically, a computer or Internet user will request information on the Internet using a web browser application that communicates with a web server. A conventional web server accesses a resource request, gets the requested information from a memory and then provides it to the user. The result may be a new web page displayed on the user's browser screen. Many times, the information requested is located on a remote data-store or disk system associated with the web server.

For example, prior art FIG. 1 is an illustration 40 of a conventional server system wherein a user 41 is coupled to a web server 43 that retrieves information from a data store 45. Initially, a user 41 makes a data request 42 that is accessed by the web server application 44. Then the web server application 44 gets the requested data file 46 from a data store 45 into the application memory 48 (copy one). Then the web server application 44 sends the file 49 to the system kernel 51 where it too copies the file 50 from application memory to the kernel memory (copy two). Once copied, the system kernel provides the file 52 to the user. Therefore, in a conventional web server, two separate copies of a requested file are made on the web server before it reaches the intended user. The first copy is made by the web server application from the data store and the second copy is made in the web server kernel from the user. This process is slow and consumes large quantities of memory.

To overcome the problems associated with making two separate copies of a requested file, some web servers began using a feature in the web server application called “sendfile” to send a file pointer (file descriptor or file path) associated with a file instead of the whole file. Sendfile handles data requests more efficiently by eliminating one of the copy functions. For instance, instead of reading a file as it is retrieved from a data store, the web server application only retrieves the file descriptor (file pointer) and then passes the pointer to the kernel and allows the kernel to read and copy the file while directly sending it out to the user, thus eliminating one copy made at the web server level.

Initially, sendfile worked sufficiently to make simple data requests more efficient by eliminating a copy on the web server level, but as data requests (web pages) became more complex (e.g., comprising multiple data files), presenting a web page required multiple data files to be retrieved. Sendfile operates on only a single file. When handling a data request that may contain multiple files, the web server must construct the web page, with all its separate files, in memory, then call the system to send this page to the user. This system call involves a second copy of the web page, as described above. Alternatively, multiple sendfile operations (system calls) are required to complete the request.

Although sendfile works with web pages that do not contain multiple file pointers, as web pages become more complex, sendfile becomes very cumbersome and time consuming because of the multiple system calls required to complete a single data request. For instance, the delay required to load individual files and wait for a kernel to read the file hinders the performance of many web servers. Therefore, there exists a need to overcome the problems associated with using conventional sendfile for web pages that contain multiple files.

### SUMMARY OF THE INVENTION

Accordingly, what is needed is a solution to the problems associated with conventional sendfile functionality. The present invention significantly increases web server performance by providing a feature that allows a web server to construct a response from chunked data (e.g., multiple files) along with any server side includes (SSI) (e.g., advertisements), using a single system call to the kernel. In one embodiment of the invention, a vectored sendfile function is provided to alleviate multiple system calls in gathering the data for a requested web page by chunking multiple file pointers into a single file vector. This single file vector (“sendfile vectors”) can be made part of a single system call to the kernel thereby causing the entire web page to be sent to the user without requiring multiple system calls and without requiring a second copy of the web page to be made. Furthermore, vectored sendfile functionality is transparent to web server application.

A system and method for vectored sendfile are presented. Embodiments of the present invention include a method for providing information comprising: accessing a data request associated with a user, wherein the data request comprises data obtained from multiple data files; identifying file descriptors associated with the data files; retrieving the file descriptors associated with the data files; and providing the file descriptors as a file vector to a system kernel in a single system call thereby causing a web page to be provided in response to the data request.

Embodiments of the present invention also include a computer implemented system for providing information comprising: a generic agent interface coupled to a server for accessing a data request associated with a user; and a generic file sending engine that identifies multiple files associated with the data request, retrieves multiple file descriptors associated with the files of the data request, constructs a sendfile vector therefrom and provides in a single system call multiple file descriptors of the vector to a system kernel.

In an embodiment of the present invention, the vectored sendfile (“sendfilev”) significantly increases web server performance by providing a method that allows a web server to construct a response from chunked data (multiple file pointers) and write a header and trailer along with any server side includes (SSI) in a single system call.

In another embodiment of the present invention, after receiving a resource request, a web server searches a cache memory for the requested data. By using a cache memory to store requested data, the web server can deliver the data to the system kernel much quicker because it does not have to retrieve the data from a remote data store.

Moreover, the files selected to comprise the web page, and which are the subject if the sendfile vector, can be determined dynamically by the web server and/or they can be read from a data resource, e.g., a disk system.

### BRIEF DESCRIPTION OF THE DRAWINGS

The accompanying drawings, which are incorporated in and form a part of this specification, illustrate embodiments of the invention and, together with the description, serve to explain the principles of the invention.

Prior art FIG. 1 is a logical block diagram of a conventional server system in which a web server intercepts a web request, locates the requested data and serves the data to a user.

FIG. 2 is a logical block diagram of an exemplary computer system in accordance with an embodiment of the present invention.

FIG. 3A is an illustration of an exemplary web page comprising multiple files and server side includes in accordance with an embodiment of the present invention.

FIG. 3B is an illustration of an exemplary sendfile vector corresponding to FIG. 3A in accordance with an embodiment of the present invention.

FIG. 4 is a logical block diagram of an exemplary server system that uses the vectored sendfile functionality to gather and send multiple file pointers in a single system kernel call in accordance with an embodiment of the present invention.

FIG. 5 is a flow diagram of the exemplary steps performed by a web server using vectored sendfile to represent a web page by a file vector and send the file vector to a kernel in a single system call in accordance with an embodiment of the present invention.

### DETAILED DESCRIPTION OF THE INVENTION

Reference will now be made in detail to the preferred embodiments of the invention, examples of which are illustrated in the accompanying drawings. While the invention will be described in conjunction with the preferred embodiments, it will be understood that they are not intended to limit the invention to these embodiments. On the contrary, the invention is intended to cover alternatives, modifications and equivalents, which may be included within the spirit and scope of the invention as defined by the appended claims. Furthermore, in the following detailed description of the present invention, numerous specific details are set forth in order to provide a thorough understanding of the present invention. However, it will be obvious to one of ordinary skill in the art that the present invention may be practiced without these specific details. In other instances, well-known methods, procedures, components, and circuits have not been described in detail as not to unnecessarily obscure aspects of the present invention.

### Notation and Nomenclature

Some portions of the detailed descriptions that follow are presented in terms of procedures, logic blocks, processing, and other symbolic representations of operations on data bits within a computer memory. These descriptions and representations are the means used by those skilled in the data processing arts to most effectively convey the substance of their work to others skilled in the art. A procedure, logic block, process, etc., is here, and generally, conceived to be a self-consistent sequence of steps or instructions leading to a desired result. The steps are those requiring physical manipulations of physical quantities. Usually, though not necessarily, these quantities take the form of electrical or magnetic signals capable of being stored, transferred, combined, compared, and otherwise manipulated in a computer system. It has proven convenient at times, principally for reasons of common usage, to refer to these signals as bits, bytes, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussions, it is appreciated that throughout the present invention, discussions utilizing terms such as “accessing,” “storing,” “retrieving,” “receiving,” “sending,” “constructing,” “compiling,” or the like, refer to the action and processes (e.g., process 500) of a computer system or similar intelligent electronic computing device, that manipulates and transforms data represented as physical (electronic) quantities within the computer system's registers and memories into other data similarly represented as physical quantities within the computer system memories or registers or other such information storage, transmission or display devices.

Although the system and method for vectored sendfile of the present invention may be implemented in a variety of different electronic systems such as a mobile computer system, a desktop computer system, an embedded system, etc., one exemplary embodiment includes the implementation on a computer server system.

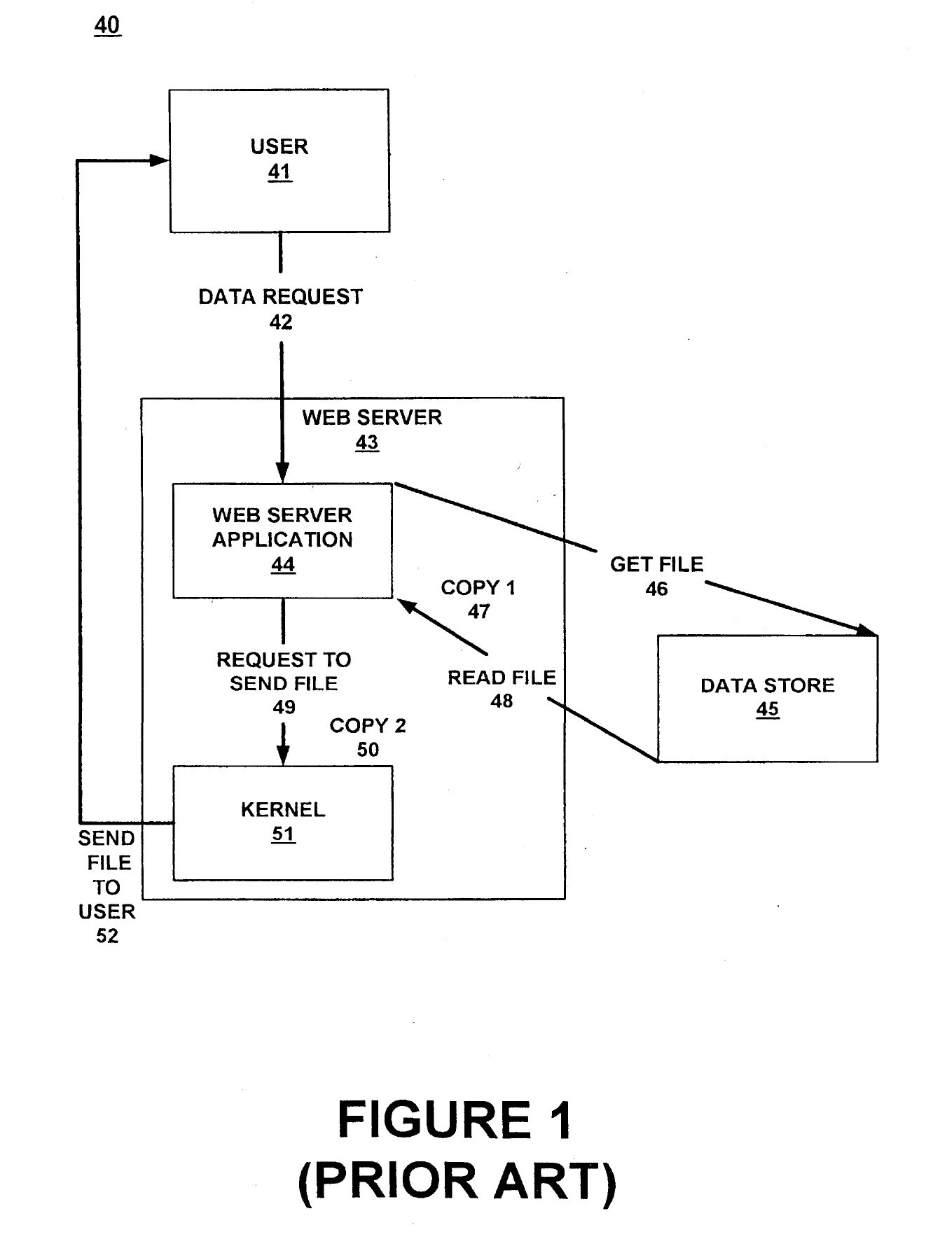

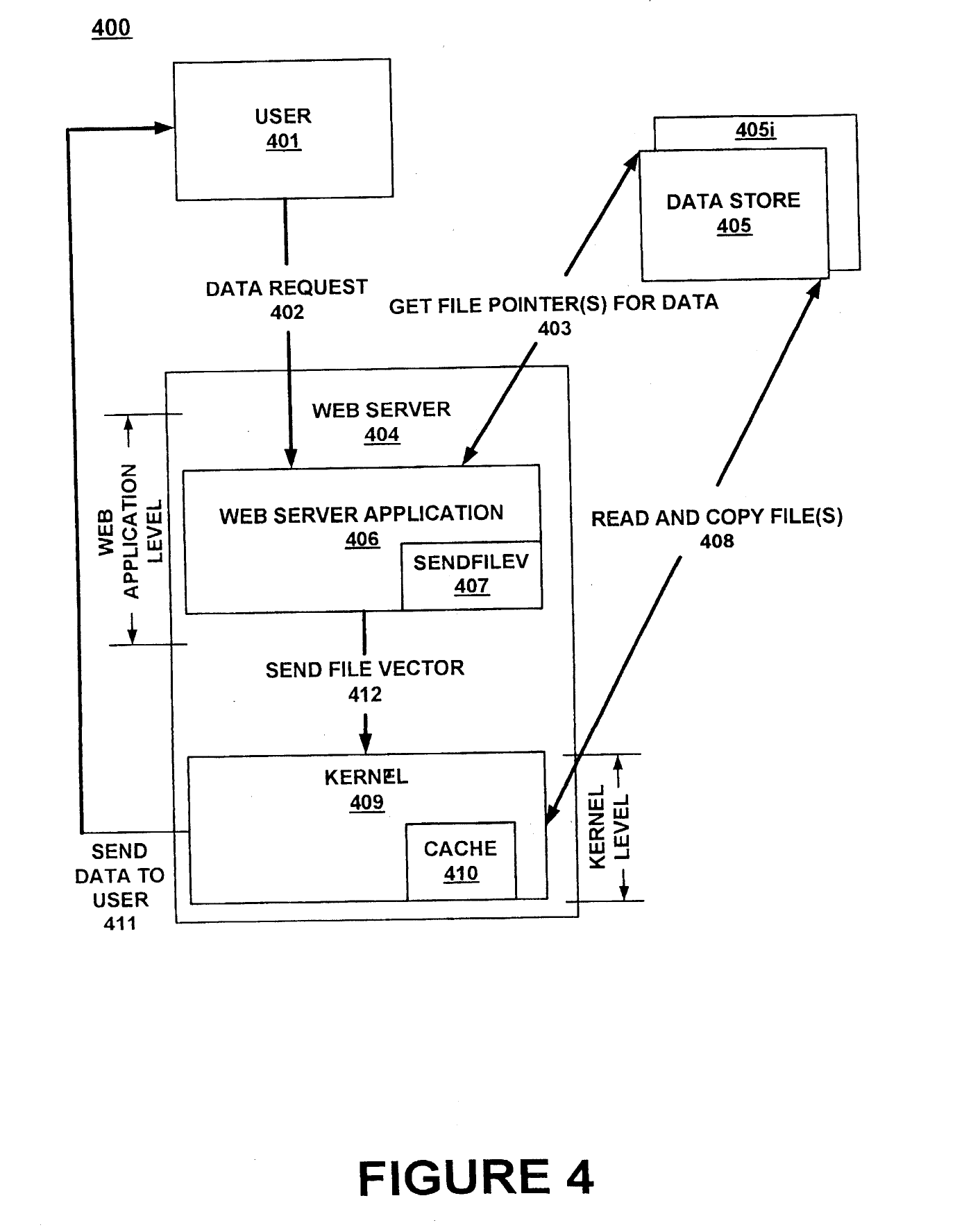

Referring now to FIG. 2, a block diagram of exemplary computer server system 12 is shown. It is appreciated that computer system 12 of FIG. 2 described herein illustrates an exemplary configuration of an operational platform upon which embodiments of the present invention can be implemented (e.g., server system 404 or user system 401 of FIG. 4). Nevertheless, other computer systems with differing configurations can also be used in place of computer system 12 within the scope of the present invention.

Computer system 12 includes an address/data bus 10 for communicating information, a central processor 1 coupled with bus 10 for processing information and instructions, a volatile memory unit 2 (e.g., random access memory, static RAM, dynamic RAM, etc.) coupled with bus 10 for storing information and instructions for central processor 1 and a non-volatile memory unit 3 (e.g., read only memory, programmable ROM, flash memory, EPROM, EEPROM, etc.) coupled with bus 10 for storing static information and instructions for processor 1. Computer system 12 may also contain an optional display device 5 coupled to bus 10 for displaying information to the computer user. Moreover, computer system 12 also includes a data storage device 4 (e.g., disk drive) for storing information and instructions. In one embodiment of the present invention, data storage device 4 is a cache memory.

Also included in computer system 12 of FIG. 2 is an optional alphanumeric input device 6. Device 6 can communicate information and command selections to central processor 1. Computer system 12 also includes an optional cursor control or directing device 7 coupled to bus 10 for communicating user input information and command selections to central processor 1. Computer system 12 also includes signal communication interface 8, which is also coupled to bus 10, and can be a serial port. Communication interface 8 can also include number of wireless communication mechanisms such as infrared or a Bluetooth protocol.

### A System and Method for Vectored Sendfile

The ability to provide multiple file pointers at the same time to a system kernel (vectored file pointers) to respond to a data request is highly desirable for a web server. For modern web servers, this functionality is useful in constructing a response from multiple files and inserting text and or advertisements in between.

Embodiments of the present invention significantly increase web server performance by providing a feature that allows a web server to construct a response from chunked data (e.g., multiple file pointers) and write a header and trailer along with any server side includes (SSI) in a single system or kernel call to provide the web page to a user. This is done without requiring a second copy made on the web server. Multiple file elements can be represented by a single file vector and can be sent to the kernel in one system or kernel call.

A generic sendfile feature does not provide optimal performance on web servers since it does not have a provision for multiple chunks of data that might come from various files. In a typical web server response, the web server adds a header, a trailer and several server side includes (SSI) in the returned file. The SSI are normally advertisements that can be cached along with a file.

Complex web pages (e.g., comprising multiple files of data) can be represented by multiple file elements that make up different portions of the web page. Each element that makes up the web page can have a file name, a file path (file pointer or file descriptor), a file offset, and file length that define how the file is viewed on the web page. The present invention provides a system and method for representing an entire web page comprising multiple file elements as a single file vector that can be delivered to a system kernel in a single system call, thus significantly increasing web server performance.

For clarity, grouped file elements will be called a “file vector”. A file element can comprise a file pointer as well as associated file offset (file start) and file length. With vectored sendfile (sendfilev), a web server can create one file vector representing multiple file elements for a chunked data request (e.g., a web page comprising multiple files) and send it to the system kernel in a single system call, thus greatly increasing the performance of the web server, especially if a requested file is cached in the kernel. The vectors can also be pointers to dynamically generated data in application memory and are not limited to files.

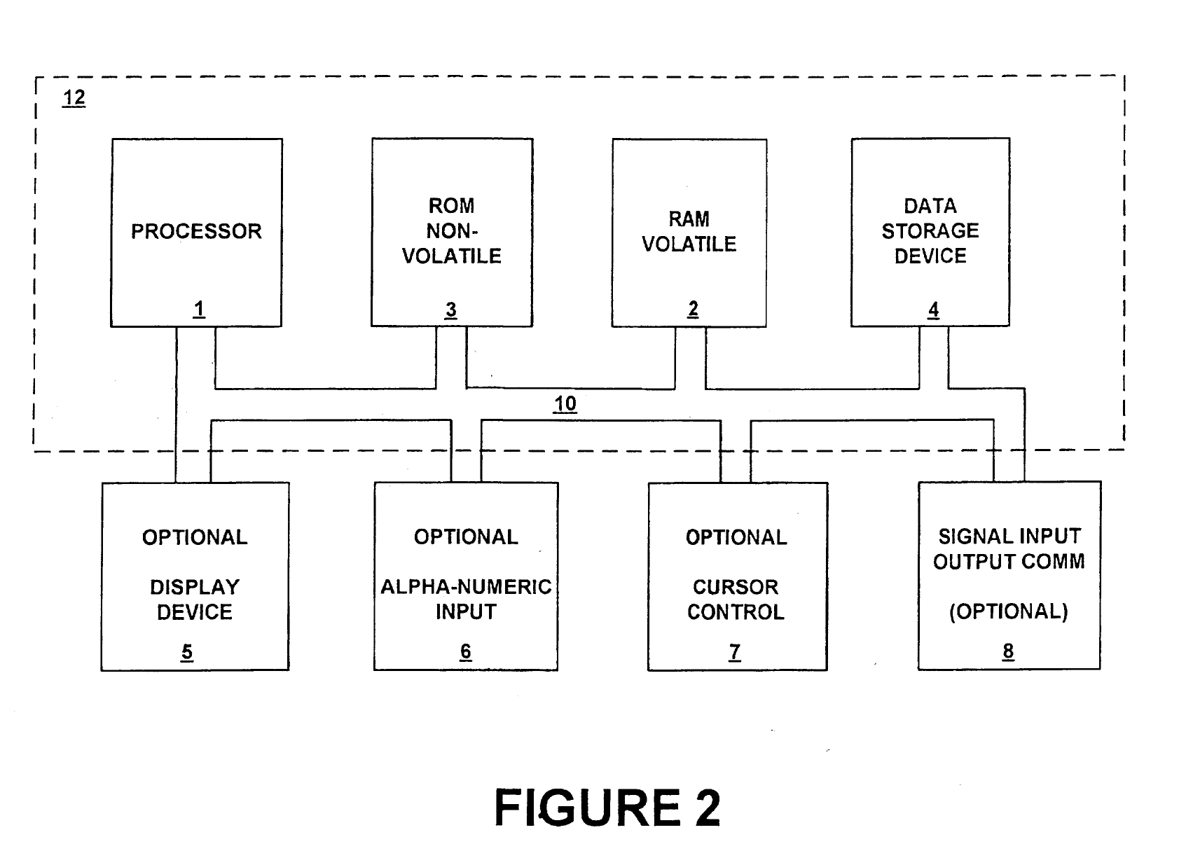

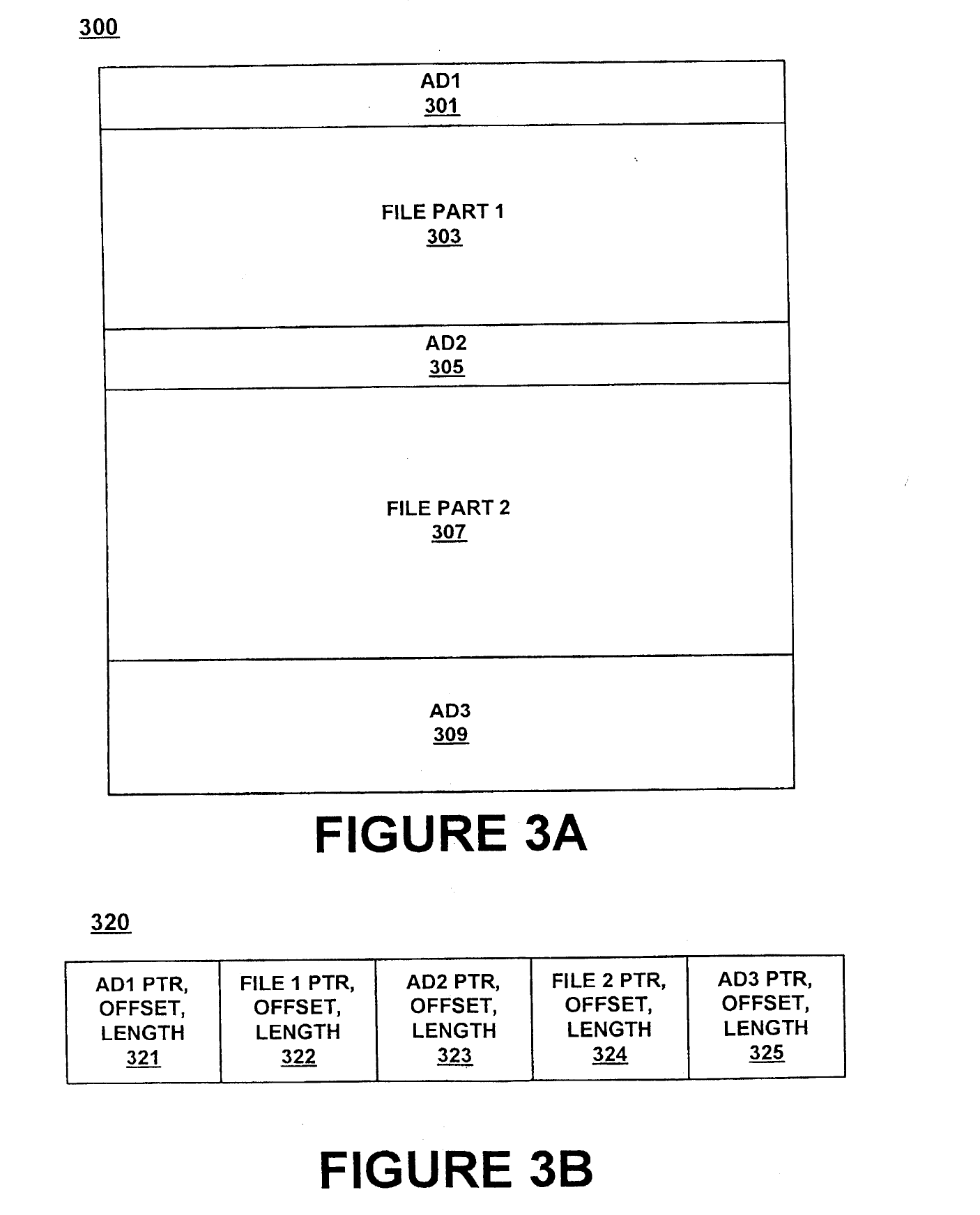

FIG. 3A is an illustration of an exemplary web page comprising multiple data files. Web page 300 comprises multiple advertisements in addition to multiple file parts. Sometimes, portions of a web page are supplied (included) by the web server. For example, sometimes advertisements are embedded in a web page by the web server. In one embodiment of the present invention, the web server can dynamically insert advertisements into the web page as server side includes (SSI). In an additional embodiment of the present invention, SSI can be stored in a cache memory coupled to a web server.

Exemplary web page 300 of FIG. 3A includes ad one 301, file part one 303, ad two 305, file part two 307, and ad three 309. To provide each of the files to the user as a single web page, the web server needs to determine a file pointer (file descriptor), an offset start point, and an offset end (file length) for each file comprising the web page. The file pointer for each file directs the kernel to the correct location (file path) of the file while the offset start and end (or offset and length) specify the portion of the file to select for the web page. With the present invention, a single file vector can represent the five different data files of web page 300 and be sent to a system kernel to provide the web page in one system call.

When a user requests a particular web resource (e.g., a particular web page), the web server determines the files that are needed to provide the page to the user. The methods for determining the files needed to present a web page are well known in the art and will not be discussed in detail for clarity.

It is important to recognize that the file pointers to particular files of a web page ca n be dynamic as well as static. For example, the file pointer corresponding to ad one 301 may change with relation to time in order to change the ad dynamically every time the page is requested or to correspond to the present date or time. For example, a web server may changes the ad displayed in a specific area of a web page every five minutes. In this case, the file pointer corresponding to the ad area of a web page will change every five minutes. A web server may rotate files for a specific area on a web page based on a time interval or files can be rotated every time the web page is requested or based on a particular user, etc. The file pointer can also point to data in application memory. The pointers can also be dynamically generated data that is not related to any particular file.

In addition, especially when using server side cache memory, the file pointer corresponding to a particular file may dynamically change because the data in the cache changes. For example, if a file was recently requested, a copy of the file may be stored in a local cache. When the file is requested again, the web server will recognize the file pointer and recognize that the file is already stored in cache. As a result, the web server will alter the file pointer sent to the kernel to point to a cache instead of a remote data store. Usually, after a period of time, the cache expires and as a result, the file pointer for the particular file will no longer point to a cache.

FIG. 3B is an illustration of an exemplary file vector 320 (or “sendfile vector”) in accordance with an embodiment of the present invention. File vector 320 is an example of a file vector that could be created by a web server using vectored sendfile when serving web page 300 of FIG. 3A. As mentioned above, once a web server receives a data request (e.g., web page request), the web server determines the files or file names that make up the entire web page. Once the files have been determined, a file pointer is determined for each file (or dynamically constructed data in application memory) as well as a file offset and file length. Once the file pointers are determined for each element, the web server generates a single file vector 320 comprising the file pointers, file offsets, and file lengths of every file comprising the web page. The file vector comprises all of the information the kernel needs to locate the files and present the page to the user. The file vector representing the entire web page is advantageously sent to the kernel in a single system call.

File vector 320 of FIG. 3B comprises file pointers for all of the files that comprise web page 300 of FIG. 3A. For example, the information needed for the kernel to retrieve and construct ad one 301 of FIG. 3A is included in portion or “element” 321 of file vector 320. Portion 321 of file vector 320 comprises a file pointer for ad one, a file offset for ad one and a file length for ad one. Likewise, portion 322 of file vector 320 corresponds to elements representing file part one 303 of FIG. 3A, portion 323 of file vector 320 corresponds to the elements representing ad two 305 of FIG. 3A, and elements 324 and 325 correspond to elements representing file part two 307 and ad three 309 of FIG. 3A respectively.

The file vector 320 comprises pointer, offset and length information for all of the separate files comprised in the complex web page 300 of FIG. 3A and can be sent to a system kernel in a single system call. The offset and length portions allow the vector to obtain all or only a portion of the identified file for incorporation into the web page.

With the present invention, a web server application can represent the entire complex data request in a single file vector and deliver it to a system kernel in one system call to serve the web page. By representing the entire complex request by a single file vector, the performance of a web server is greatly increased because the number of system calls associated with a request is only one as opposed to numerous system calls previously required without vectored sendfile. By using a vectored sendfile (“sendfilev”), multiple calls between a web server application and a system kernel related to a single data request are eliminated, thus increasing performance. Moreover, since the kernel directly reads the files from their pointer locations, and sends out the web page, only one copy of the web page contents are made by the server when serving the web page. In addition, web server speed is further increased when requested files are stored in a cache memory coupled to the kernel.

It is appreciated that a single sendfile vector can represent an entire complex web page. Also, a sendfile vector may point to another sendfile vector.

FIG. 4 is a block diagram of an exemplary server system 400 that uses sendfilev 407 (vectored sendfile) to represent multiple data files and send in one system call to a kernel. Web server application 406 communicates with system kernel 409 and data store 405. A resource request 402 (e.g., for a web page) is made from a user 401 to the web server 404. Once the web server accesses the request, the web server determines the different files associated with the request and gets 403 the file pointers associated with the request from data store 405. In addition to the file pointers, the web server determines file offsets and lengths for all of the individual files used in the web page.

After determining the file pointers associated with the request, the web server application 404 generates and sends a single file vector 412 comprising all of the file pointers, offsets and lengths to the system kernel 409. The kernel then retrieves via a single sendfile vector system call and copies the files represented by the file vector 408. In one embodiment, the kernel may retrieve one or more data files from a cache memory 410. Once the kernel 409 has retrieved files represented by the file vector, the kernel compiles the data and provides the file (web page) to the user 411. It is important to note that the operation of the kernel 409 is transparent to the web server application 406. Furthermore, the data used by the kernel 409 is directly read from the data store 405 or cache 410, thereby eliminating the need for a web-server-application-copy of the web page.

In one embodiment of the present invention, a web resource request (e.g., web page) may contain file pointers (file descriptors) that reside on different data store 405. For example, in one embodiment of the present invention, web server 404 stores server side includes such as advertisements that can be embedded into requested data (web page) before the page is presented to the user. The server side includes (SSI) can be stored in a cache or on any other memory device.

Table one illustrates one example of the data structure of a sendfile vector that can provide vectored sendfile on a web server in accordance with one embodiment of the present invention.

```
TABLE ONE
    ssize_t sendfilev (int socket, const struct svf *vec, int sfvcnt);
    struct sfv {
        int sfv_type;
        union {
```

| int sfv_fd; | | /* input fd */ |
|---|---|---|
| caddr_t sfv_file; | | /* filename */ |
| caddr_t sfv_data; | | /* data pointer */ |
| } sfv_base; | | |
| off_t sfv_off; | | /* offset to start */ |
| ssize_t sfv_len; | | /* amount of data */ |
| } svf_t; | | |
| The type can be: | | |
| #define sfv_fd | 0x01 | /*sfv_base is a file descriptor */ |
| #define sfv_file | 0x02 | /* sfv_base is a file name */ |
| #define sfv_data | 0x03 | /* sfv_base has data */ |

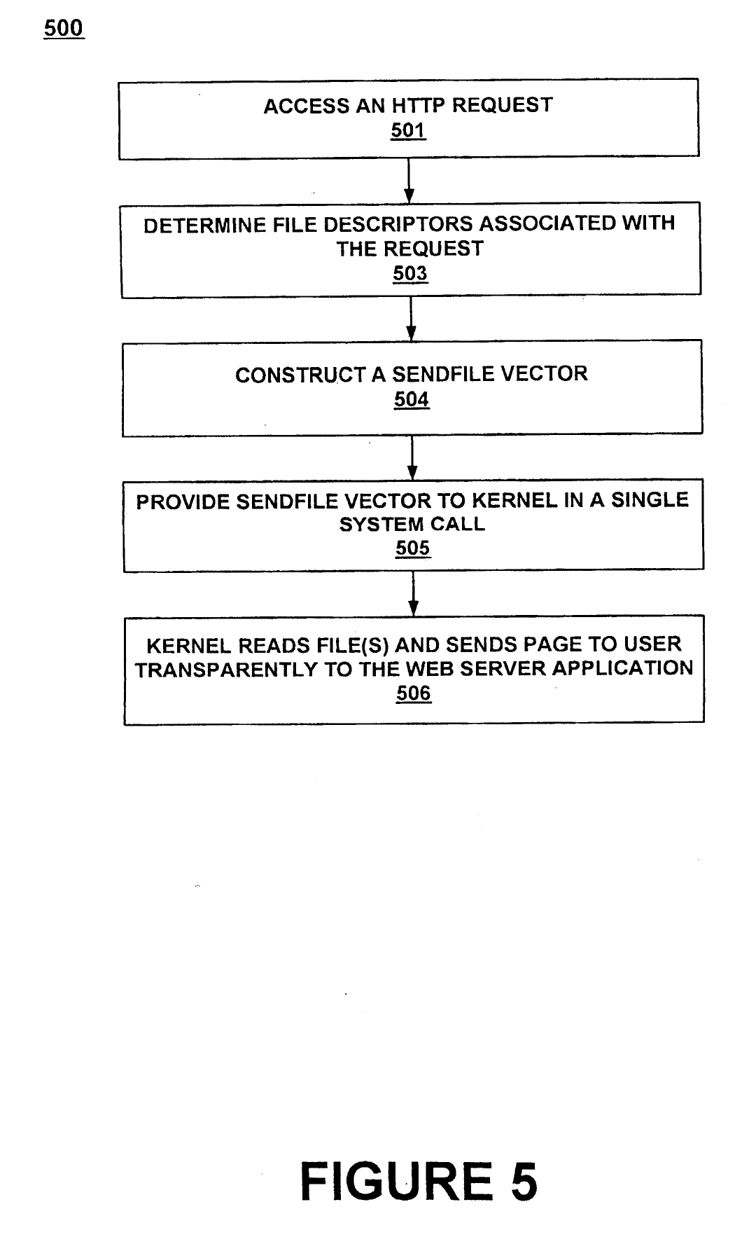

FIG. 5 is a flow diagram of an exemplary computer implemented process 500 wherein “sendfilev” identifies multiple files associated with a data request and compiles multiple file pointers, file offsets and lengths into a single file vector and then sends the file vector to the kernel in one system call. The first step 501 is to access an http request for data (e.g., a complex web page request). The next step 503 is for the web server to determine the file pointers (descriptors) associated with the http request. At this point, the web application of the web server accesses a data store to retrieve the file pointers associated with the complex web page that was requested.

As mentioned above, in one embodiment of the present invention, the file pointer for a particular file can be time sensitive and can dynamically change or 15′ can be changed by the web server. The file pointers are typically retrieved from a remote data store such as a directory server. The file pointers used in the vector sendfile are free of paths and pathnames and are of a lower level data structure identifying the machine locations, e.g., addresses, of the files. The offset and length data are of the analogous data format.

Next, in step 504, the web server application of the web server constructs a file vector (“sendfile vector”) comprising the file pointers determined in step 503 in addition to other file elements such as file offset and length. At this time, the web server can add server side includes (SSI) such as advertisements to complete the file vector. Each server side include will have its own file pointer, file offset and file length that is included in the file vector. In addition to SSI, the web server can add header and trailer information to the send file vector. The constructed file vector represents the requested complex web page.

Next, in step 505, the sendfile vector is provided to the kernel in a single system call. Once the kernel accesses the file vector, in step 506, it locates the files, reads the files (from data store 405 or cache 410), and compiles the files into a complex web page as it is sent to the user all done transparently to the web server application.

The performance of the web server is further increased if one or more of the files is located on a local cache memory. Many times, a previously requested file is stored in a cache for a period of time in case it is requested again. If the resource is requested again, and the cache has not been cleared, the time to retrieve the file from cache is significantly less than if it was retrieved from a remote data store such as a directory server.

Accordingly, with vectored sendfile (sendfilev), a web application on a web server can retrieve multiple file pointers associated with the request and send it in a single system call to the kernel without the need to compile the web page on the web application level. As a result, fewer system calls are made by the web server thus, web server performance increases drastically. Web server performance also increases because the complex web page does not need to be compiled at the web application level, but rather only at the kernel level.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The embodiments were chosen and described in order to best explain the principles of the invention and it's practical application, to thereby enable others-skilled in the art to best utilize the invention and various embodiments with various modifications as are suited to the particular use contemplated. It is intended that the scope of the invention be defined by the claims appended hereto and their equivalents.

What is claimed is:

1. A computer implemented method for providing information comprising:
a) accessing a data request associated with a user, wherein said data request comprises a request for a complex web page;
b) identifying data files that represent said complex web page;
c) retrieving file descriptors associated with said data files; and
d) providing said file descriptors as a file vector to a system kernel in a single system call to serve said complex web page.

2. The method as described in claim 1 wherein a file descriptor is a pointer to a data store containing a file.

3. The method as described in claim 1 wherein a file descriptor points to a cache memory containing a file.

4. The method as described in claim 1 wherein said data files comprise server side includes.

5. The method as described in claim 4 wherein at least one server side include is an advertisement file.

6. The method as described in claim 4 wherein at least one server side include is retrieved from a cache memory.

7. The method as described in claim 1 wherein each of said file descriptors comprise: a file pointer; a file offset start; and a file length.

8. The method as described in claim 1 wherein said b) is performed dynamically.

9. A computer implemented system for providing information comprising:
a) a system kernel for receiving a vector representing a plurality of files which comprise a web page and for serving said web page; and
b) a web server program for accessing a data request and identifying multiple files associated with said data request and retrieving multiple file descriptors associated with said files, and providing in a single system call a file vector comprising said multiple file descriptors to said system kernel.

10. The computer implemented system as described in claim 9 wherein a file descriptor points to a file in a remote data store.

11. The computer implemented system as described in claim 9 wherein a file descriptor points to a file in a cache memory of said system kernel.

12. The computer implemented system as described in claim 9 wherein at least one of said multiple files is a server side include.

13. The computer implemented system as described in claim 12 wherein said server side include is an advertisement file.

14. The computer implemented system as described in claim 12 wherein said server side include is retrieved from a cache memory.

15. A method for serving a complex web page to a user comprising:
a) accessing an http request from a user;
b) retrieving a plurality of file pointers associated with said complex web page of said http request;
c) providing said plurality of file pointers to a system kernel in a single system call;
d) compiling a plurality of files associated with said plurality of said file pointers to construct said complex web page; and
e) providing said complex web page over a communication interface, wherein said d) and e) are performed by said system kernel.

16. The method as described in claim 15 wherein a file pointer points to a remote data store.

17. The method as described in claim 15 wherein a file pointer points to a cache memory.

18. The method as described in claim 15 wherein said plurality of files comprises at least one server side include.

19. The method as described in claim 18 wherein said server side include is an advertisement file.

20. The method as described in claim 18 wherein said server side include is retrieved from a cache memory.

21. A computer server implemented method of providing information comprising:
a) accessing a request for a web page;
b) determining a vector corresponding to said web page, said vector comprising a plurality of pointers corresponding to a plurality of files for said web page;
c) providing said vector to a system kernel using a single system call; and
d) in response to said single system call, said kernel using said vector to read said plurality of files from a storage medium and said kernel providing said plurality of files to a network communication interface to provide said web page.

22. A method as described in claim 21 wherein said storage medium is a disk system.

23. A method as described in claim 22 wherein said vector further comprises respective offset and length for each of said plurality of pointers.

24. A method as described in claim 22 wherein said b) is performed by said server accessing said disk system to obtain said vector corresponding to said web page.

25. A method as described in claim 22 wherein said b) is performed by said server dynamically constructing said vector in response to said request.

26. A method as described in claim 21 wherein a first portion of said plurality of files are stored on a disk system and wherein a second portion of said plurality of files are stored in random access memory on said server system.

27. A method as described in claim 21 wherein one of said plurality of pointers points to another vector that points to files.

28. A computer server system comprising:
a) a web server application for performing:
a1) accessing a request for a web page;
a2) determining a vector corresponding to said web page, said vector comprising a plurality of pointers corresponding to a plurality of files for said web page; and
a3) providing said vector to a system kernel using a single system call; and
b) wherein, in response to said single system call, said kernel using said vector to read said plurality of files from a storage medium and wherein further said kernel directly providing said plurality of files to a network communication interface to provide said web page.

29. A computer server system as described in claim 28 wherein said storage medium is a disk system.

30. A computer server system as described in claim 29 wherein said vector further comprises a respective offset and length for each of said plurality of pointers.

31. A computer server system as described in claim 29 wherein said a2) is performed by said server application accessing said disk system to obtain said vector corresponding to said web page.

32. A computer server system as described in claim 29 wherein said a2) is performed by said server application dynamically constructing said vector in response to said request.

33. A computer server system as described in claim 28 wherein a first portion of said plurality of files are stored on a disk system and wherein a second portion of said plurality of files are stored in random access memory on said server system.

34. A computer server system as described in claim 28 wherein one of said plurality of pointers points to another vector that points to files.

35. A computer server system as described in claim 28 wherein said kernel directly provides said plurality of files to said network communication interface transparently to said web server application.
